(19) United States
(12) Patent Application Publication
(10) Pub. No.: US 2009/0064425 A1
(43) Pub. Date: Mar. 12, 2009

(54) Polymer/Clay Nanocomposite Films with Improved Light Fastness Properties and Process for Producing Same

(75) Inventors: Walter Scrivens, Moore, SC (US); Dongling Fei, Bradenton, FL (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 11/911,091

(22) PCT Filed: Apr. 10, 2006
(86) PCT No.: PCT/US2006/013256

§ 371 Date: Oct. 20, 2008

Related U.S. Application Data
(60) Provisional application No. 60/669,648, filed on Apr. 8, 2005.

(51) Int. Cl. D06P 3/00; B32B 18/00; D06P 3/79; D06P 3/40; C08K 3/34; C08K 5/23; D06P 3/24; B32B 5/16

(52) U.S. Cl. 8/508; 428/325; 8/509; 8/513; 8/514; 8/515; 8/516; 8/519; 524/190; 524/445

(57) ABSTRACT

A colored polymeric material having improved light fastness is generally provided. The colored polymeric material generally comprises a polymer, a colorant, and natural nanoparticles. The colorant can be a dye, such as an acid dye. In one embodiment, the dye can be susceptible to degradation when exposed to light in the presence of oxygen, such as many azo dyes. The natural nanoparticles can include many natural clays.

### CROSS-REFERENCE TO RELATED APPLICATIONS

The present application claims priority to U.S. Provisional Patent Application No. 60/669,648 filed on Apr. 8, 2005, titled “Polymer/Clay Nanocomposite Films with Improved Light Fastness Properties and Process for Producing Same” and naming Walter Scrivens, et al. as inventors, which is hereby incorporated by reference.

### BACKGROUND OF THE INVENTION

Polymer nanocomposites have recently attracted much attention due to their significantly improved mechanical and physical properties compared to the pristine polymer and other conventional micron sized composites. Nanoscaled layer silicates, such as montmorillonite and hectorite, have been used as modifiers in a variety of polymeric matrices to produce nanocomposites. These materials have manifested higher modulus, better dimensional stability, and improved gas barrier and flame retardation.

Polymeric materials are used in an almost limitless variety of applications. For instance, thermoplastic polymers are used to form films, fibers, filaments, and may also be molded or extruded into various useful articles. In many applications the polymeric materials include a dye or other colorant within the polymeric matrix. However, research has shown that these polymers alone, when dyed and exposed to light, exhibit fading.

As such, a need exists for a dyed or otherwise colored polymeric material that has improved light fastness. Also, a need exists for a dyed or colored polymeric material that resists fading without significantly changing the properties of the polymeric material.

The present invention involves a new method of producing polymer/clay nanocomposite films, with focus on enhancing the light fastness properties of polymer films to resist fading.

### SUMMARY OF THE INVENTION

In one embodiment, the present invention is generally directed to a colored polymeric material comprising a polymer, a natural nanoparticle, and a colorant. The natural nanoparticle has a greatest dimension of less than about 5,000 nanoparticles. The colored polymeric material has increased light fastness when compared to an otherwise colored control polymeric material without the natural nanoparticles. The colorant can comprise a dye, such as an acid dye. In one embodiment, the dye can comprise an azo dye. For example, the dye can be susceptible to degradation when exposed to light in the presence of oxygen. The natural nanoparticles can comprise natural clays, such as natural clays that are layered in an agglomeration of individual platelet particles that have a thickness of less than about 20 nanometers and a diameter of about 10 nanometers to about 5,000 nanometers. In one embodiment, the natural particles can comprise montmorillonite clays.

In one particular embodiment, the polymer can comprise a hydrogel polymer, such as a hydrogel polymer that forms a cross-linked matrix.

In another embodiment, the present invention is directed to a method of making a colored polymeric material having increased light fastness. The method comprises exfoliating natural clay nanoparticles into a polymeric material and dyeing the polymeric material with a dye. The natural clay nanoparticles have a greatest dimension of less than about 5,000 nanometers, a thickness of less than about 20 nanometers, and are selected from the group consisting of smectite clays and modified clays. The dye can be susceptible to degradation when exposed to light in the presence of oxygen.

### DESCRIPTION OF DRAWINGS

FIG. 1 shows the maximum absorption over time in a control film compared to a film made according to the present invention;

FIG. 2a shows a typical TEM image of montmorillonite in 0.7 wt % montmorillonite water suspension;

FIG. 2b shows a typical AFM image of the montmorillonite in 0.7 wt % montmorillonite water suspension;

FIGS. 3a and 3b show exfoliation of the montmorillonite platelets in the composite films; and

FIGS. 4 and 5 show the refractive indices of composite films at various montmorillonite weight loadings.

### DETAILED DESCRIPTION OF INVENTION

It is to be understood by one of ordinary skill in the art that the present discussion is a description of exemplary embodiments only, and is not intended as limiting the broader aspects of the present invention.

The present invention is generally directed to colored polymer composite materials that have improved light fastness. In addition to improved light fastness, however, it should be understood that the composite polymeric materials may also exhibit other improved properties, such as improved gas barrier properties. For instance, the composite materials may be formulated to have physical properties that are particularly well suited for a specific application. The invention shows that a colored polymer nanocomposite film created by adding the natural nanoparticles to a polymer exhibits enhanced light fastness properties over the colored polymer alone.

For instance, when exposed to light (e.g., natural light, visible light, and/or ultra violet light), the dyed or otherwise colored polymer/nanoparticle composite can exhibit reduced fading when compared to the same dyed or otherwise colored polymer matrix without the presence of such nanoparticles. However, the present inventors here found that through careful selection of natural nanoparticles and colorants, the light fastness of the colorant in the polymeric material can be increased.

The resulting colored polymeric composite shows improved light fastness over a colored polymeric material without the nano-sized natural particles. In addition to the improved light fastness, however, it should be understood that the composite polymeric materials may also exhibit other improved properties, such as improved gas barrier properties. For instance, the composite materials may be formulated to have physical properties that are particularly well suited for a specific application. The invention shows that a colored polymer nanocomposite film created by adding natural clay nanoparticles to a polymer, exhibits enhanced light fastness properties over the colored polymer alone.

For instance, when exposed to light (e.g., natural light, visible light, and/or ultra-violet light), the dyed or otherwise colored polymer/nanoparticle composite can exhibit reduced fading when compared to the same dyed or otherwise colored polymeric matrix without the presence of such nanoparticles. However, the present inventors have found that through careful selection of natural clay nanoparticles and colorants, the light fastness of the color in the polymeric material can be increased.

In general, the dyed or otherwise colored polymeric composite materials include a polymer matrix containing nano-sized natural particles and a colorant.

### Natural Nanoparticles

According to the present invention, any natural nanoparticle can be used, such as clays. For example, useful clay nanoparticles include natural clays and modified phyllosilicates. Natural clays include smectite clays, such as montmorillonite, saponite, hectorite, mica, vermiculite, bentonite, nontronite, beidellite, volkonskoite, magadite, kenyaite, and the like. Modified clays include fluorinated hectorite, fluorinated mica, and the like. Suitable clays are available from various companies including Nanocor, Inc., Southern Clay Products, Kunimine Industries, Ltd., and Rheox. In one embodiment, the clays can have less than about 2.0 wt % of quartz, as measured by powder X-ray diffraction methods, such as described in U.S. Pat. No. 6,737,464, which is hereby incorporated by reference.

The nanocomposite compositions of the present invention comprise up to about 25 weight percent, preferably from about 0.5 to about 20 weight percent, more preferably from about 0.5 to about 15 weight percent, and most preferably from about 0.5 to about 10 weight percent of layered clay material. The layered clay material comprises platelet particles. The amount of platelet particles is determined by measuring the amount of silicate residue in the ash of the polymer/platelet composition when treated in accordance with ASTM D5630-94.

Generally, the layered clay materials useful in this invention are an agglomeration of individual platelet particles that are closely stacked together like cards, in domains called tactoids. The individual platelet particles of the clays preferably have thickness of less than about 2 nm and diameter in the range of about 10 to about 5000 nm. For the purposes of this invention, measurements refer only to the platelet particle and not any dispersing aids or pretreatment compounds which might be used.

In one embodiment, the clays are dispersed in the polymer(s) so that most of the clay material exists as individual platelet particles, small tactoids, and small aggregates of tactoids. Preferably, a majority of the tactoids and aggregates in the polymer-clay nanocomposites of the present invention will have thickness in its smallest dimension of less than about 20 nm. Polymer-clay nanocomposite compositions with the higher concentration of individual platelet particles and fewer tactoids or aggregates are preferred.

Moreover, the layered clay materials are typically swellable free flowing powders having a cation exchange capacity from about 0.3 to about 3.0 milliequivalents per gram of mineral (meq/g), preferably from about 0.90 to about 1.5 meq/g, and more preferably from about 0.95 to about 1.25 meq/g. The clay may have a wide variety of exchangeable cations present in the galleries between the layers of the clay, including, but not limited to cations comprising the alkaline metals (group IA), the alkaline earth metals (group IIA), and their mixtures. The most preferred cation is sodium; however, any cation or combination of cations may be used provided that most of the cations may be exchanged for organic cations. The exchange may occur by treating an individual clay or a mixture of clays with organic cation or a mixture of organic cations.

Preferred clay materials are phyllosilicates of the 2:1 type having a cation exchange capacity of about 0.5 to about 2.0 meq/g. The most preferred clay materials are smectite clay minerals, particularly sodium bentonite or sodium montmorillonite, more particularly Wyoming-type sodium montmorillonite or Wyoming-type sodium bentonite having a cation exchange capacity from about 0.95 to about 1.25 meq/g.

Other non-clay materials having the above-described ion-exchange capacity and size, such as chalcogens, may also be used as a source of platelet particles under the present invention. Chalcogens are salts of a heavy metal and group VIA (O, S, Se, and Te). These materials are known in the art and do not need to be described in detail here.

Improvements in gas barrier result from increases in the concentration of platelet particles in the polymer. While amounts of platelet particles as low as about 0.01 percent provide improved barrier (especially when well dispersed and ordered), compositions having at least about 0.5 weight percent of the platelet particles are preferred because they display the desired improvements in gas barrier.

Prior to incorporation into an oligomer(s) or polymer(s), the particle size of the clay material may be reduced in size by methods known in the art, including, but not limited to, grinding, pulverizing, hammer milling, jet milling, and their combinations. It is preferred that the average particle size be reduced to less than about 100 micron in diameter, more preferably less than about 50 micron in diameter, and most preferably less than about 20 micron in diameter.

The clay material of this invention may comprise refined or purified but unmodified clays, modified clays, or mixtures of modified and unmodified clays. Generally, it is desirable to treat the selected clay material to facilitate separation of the agglomerates of platelet particles to individual platelet particles and small tactoids. Separating the platelet particles prior to incorporation into the polymer also improves the polymer/platelet interface. Any treatment that achieves the above goals may be used.

Many clay treatments used to modify the clay for the purpose of improving dispersion of clay materials are known and may be used in the practice of this invention. The clay treatments may be conducted prior to, during, or after mixing the clay material with the polymer.

Exfoliation into Polymer Matrix

The natural clay materials are generally in the form of relatively large agglomerations when purchased commercially. The agglomerations have a layered structure. When the particles are to be incorporated into a polymer for improving the light fastness properties of the colored polymer, the layered structures may be broken down in a process known as exfoliation. During exfoliation, the layered structure is broken down such that the resulting particles have a thickness in the nanometer size range. Of particular advantage, the natural clay materials may be exfoliated in a relatively simple process without having to treat the natural clays with various chemical additives.

After exfoliation, the particles may be present in individual layers or may be present as tactoids which may contain from about 2 to about 20 layers of the material. Exfoliation according to the present invention may occur in various carrier materials. For instance, the carrier material may be a liquid or solid. In one particular embodiment, the particles may be exfoliated directly into a polymer during melt processing.

In one embodiment, the particles may be easily exfoliated into various liquids. The liquids may then be incorporated into a polymer, for instance, during formation of the polymer.

For example, natural clay materials have been found to be easily exfoliated into liquids such as aqueous solutions, water, liquid glycols, or various other solvents. Once exfoliated into a liquid, a suspension forms that is relative stable. The suspension may contain an ingredient that reacts with the monomer to form a polymer or may otherwise be present during the polymerization of a polymer. In this manner, the particles may be incorporated into any polymeric material that is capable of being polymerized in the presence of a liquid. Such polymers include polymers that form in a solution polymerization process or in an emulsion polymerization process. In other embodiments, the particle may be incorporated into a polymer that is dissolved in a liquid and later reformed.

In one particular embodiment, for instance, the particles are exfoliated in an aqueous solution. The aqueous solution may consist essentially of water or may contain water and other liquids. For example, in one embodiment, a base may be added in order to facilitate exfoliation. The base may be, for instance, an organic base or a metal hydroxide, such as sodium hydroxide. In other embodiments, however, a base may not be needed.

Once the natural clay particles are added to the aqueous solution, the solution may be subjected to various physical forces until the particles are substantially exfoliated. For example, the solution may be subjected to shear forces by stirring the solution or by sonicating the solution. In general, as many particles as possible are added to the aqueous solution. For instance, the particles may be added until the solution has reached its maximum carrying capacity. For many applications, for instance, the particles may be added to the aqueous solution in an amount of up to about 10% by weight, such as in an amount up to 5% by weight. In one embodiment, for example, the particles may be added to the aqueous solution in an amount of from about 1% to about 2% by weight.

The percentage of particles that become exfoliated in the aqueous solution depends on various factors, including the particular natural nanoparticle that is used. In general, it is believed that at least 80% of the particles may be exfoliated in the liquid, such as at least about 85% of the particles. As described above, once exfoliated, the particles are in the form of a single layer of the material or in the form of tactoids containing a relatively small amount of layers, such as less than about 20 layers. After exfoliation, various physical means may be used in order to remove any larger particles that remain. For example, the larger particles may settle out and be removed or the solution may be centrifuged in order to remove the larger particles.

In order to be incorporated into a polymer material, the aqueous suspension may be mixed with a polymer during extrusion, mixed with a monomer which is then polymerized into a polymer, or may be combined with a solution containing a dissolved polymer for later forming films and the like.

In addition to aqueous solutions, the particles may be exfoliated into other liquids. For example, when exfoliating the particles into a polyester, such as PET, the particles may first be exfoliated into ethylene glycol. Ethylene glycol has been found to act as a swelling agent that causes the individual particles to swell and break apart when subjected to shear forces, such as during sonication. After exfoliation, an ethylene glycol suspension containing the particles is formed. Again, the suspension may contain the particles in an amount up to about 5% by weight, such as in an amount up to about 2% by weight. Further, the suspension may be centrifuged in order to remove any particles that are not exfoliated.

Of particular advantage in this embodiment, ethylene glycol is an original reactant in the formation of PET polymers. Thus, the ethylene glycol suspension may be combined with a PET monomer, such as bishydroxyethylterephthalate. The monomer and ethylene glycol suspension may then be heated in the presence of a catalyst to create a PET polymer. Through this process, the particles become well dispersed throughout the PET polymer matrix. Once present in the matrix, the particles can dramatically improve the gas barrier properties of the material. Also, as the present inventors have found, the particles can improve the light fastness of a polymeric material that also includes a colorant.

Exfoliating the particles into a liquid prior to being combined with a polymer ensures that the polymers are well dispersed throughout the polymer. In other embodiments, however, the particles may be added directly to an extruder or otherwise melt process with a thermoplastic polymer. In this embodiment, the particles may be combined with the thermoplastic polymer while the thermoplastic polymer is in a molten state and while the materials are under high shear forces, such as may occur in a screw extruder. In this manner, the particles may be exfoliated into the polymer without the necessity of first exfoliating the particles into a liquid.

As described above, in still another embodiment of the present invention, the particles may be exfoliated into a liquid, such as an aqueous solution that contains a soluble polymer. Once the particles are exfoliated into the liquid, the liquid may be used to form polymeric articles, such as films. In one particular embodiment, for instance, the particles may be dispersed in a solution that contains agarose or polyvinyl alcohol in an amount less than about 10% by weight, such as less than about 5% by weight. For example, in one embodiment, the solution may contain one of the polymers in an amount of about 1% by weight. The particles may be incorporated into the solution in an amount up to about 80% by weight, such as from about 20% by weight to about 50% by weight. Of particular advantage, films made containing up to 50% by weight of the particles remain transparent even at the relatively high particle loading.

### Polymeric Materials

In general, the particles may be added to any polymeric material that is compatible with the particles. The particles may be added to the polymer in order to improve the light fastness of the polymer when colored or to otherwise change the physical properties of the material (e.g., the gas barrier properties). A non-exhaustive list of polymers that may be combined with the particles include polyesters such as PET, polyetheresters, polyanides, polyesteramides, polyurethanes, polyimides, polyetherimides, polyureas, polyamideimides, polyphenyleneoxides, phenoxy resins, epoxy resins, polyolefins such as polyethylenes and polypropylenes, polyacrylates, polystyrenes, polyethylene-co-vinyl alcohols, polyvinyl chlorides, polyvinyl alcohols, cellulose acetates, agarose, and the like. The particles may also be added to combinations of polymers. The polymers may comprise homopolymers, copolymers, and terpolymers. The polymers may be branched, linear, or cross-linked.

In one particular embodiment, the particles are incorporated into a polyethylene terephthalate or a copolymer thereof. The polyester may be prepared from one or more of the following dicarboxylic acids and one or more of the following glycols.

The dicarboxylic acid component of the polyester may optionally be modified with up to about 50 mole percent of one or more different dicarboxylic acids. Such additional dicarboxylic acids include dicarboxylic acids having from 3 to about 40 carbon atoms, and more preferably dicarboxylic acids selected from aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of suitable dicarboxylic acids include phthalic acid, isophthalic acid, naphthalene-2,6-dicarboxylic acid, cyclohexanedicarboxylic acid, cyclohexanediacetic acid, diphenyl-4,4′-dicarboxylic acid, phenylene (oxyacetic acid) succinic acid, glutaric acid, adipic acid, azelaic acid, sebacic acid, and the like. Polyesters may also be prepared from two or more of the above dicarboxylic acids.

Typical glycols used in the polyester include those containing from two to about ten carbon atoms. Preferred glycols include ethylene glycol, propanediol, 1,4-butanediol, 1,6-hexanediol, 1,4-cyclohexanedimethanol, diethylene glycol and the like. The glycol component may optionally be modified with up to about 50 mole percent, preferably up to about 25 mole percent, and more preferably up to about 15 mole percent of one or more different diols. Such additional diols include cycloaliphatic diols preferably having 3 to 20 carbon atoms or aliphatic diols preferably having 3 to 20 carbon atoms. Examples of such diols include: diethylene glycol, triethylene glycol, 1,4-cyclohexanedimethanol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(2-hydroxyethoxy)-benzene, 2,2b-is-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane and the like. Polyesters may also be prepared from two or more of the above diols.

Small amounts of multifunctional polyols such as trimethylolpropane, pentaerythritol, glycerol and the like may be used, if desired. When using 1,4-cyclohexanedimethanol, it may be the cis, trans or cis/trans mixtures. When using phenylenedi(oxyacetic acid), it may be used as 1,2; 1,3; 1,4 isomers, or mixtures thereof.

The polymer may also contain small amounts of trifunctional or tetrafunctional comonomers to provide controlled branching in the polymers. Such comonomers include trimellitic anhydride, trimethylolpropane, pyromellitic dianhydride, pentaerythritol, trimellitic acid, trimellitic acid, pyromellitic acid and other polyester forming polyacids or polyols generally known in the art.

Suitable polyamides include partially aromatic polyamides, aliphatic polyamides, wholly aromatic polyamides and/or mixtures thereof. By “partially aromatic polyamide,” it is meant that the amide linkage of the partially aromatic polyamide contains at least one aromatic ring and a nonaromatic species. Suitable polyamides have an article forming molecular weight and preferably an I.V. of greater than 0.4.

Preferred wholly aromatic polyamides comprise in the molecule chain at least 70 mole % of structural units derived from m-xylylene diamine or a xylylene diamine mixture comprising m-xylylene diamine and up to 30% of p-xylylene diamine and an aliphatic dicarboxylic acid having 6 to 10 carbon atoms, which are further described in Japanese Patent Publications No. 1156/75, No. 5751/75, No. 5735/75 and No. 10196/75 and Japanese Patent Application Laid-Open Specification No. 29697/75.

Polyamides formed from isophthalic acid, terephthalic acid, cyclohexanedicarboxylic acid, meta- or para-xylylene diamine, 1,3- or 1,4-cyclohexane(bis)methylamine, aliphatic diacids with 6 to 12 carbon atoms, aliphatic amino acids or lactams with 6 to 12 carbon atoms, aliphatic diamines with 4 to 12 carbon atoms, and other generally known polyamide forming diacids and diamines can be used. The low molecular weight polyamides may also contain small amounts of trifunctional or tetrafunctional comonomers such as trimellitic anhydride, pyromellitic dianhydride, or other polyamide forming polyacids and polyamines known in the art.

Preferred partially aromatic polyamides include, but are not limited to poly(m-xylylene adipamide), poly(m-xylylene adipamide-co-isophthalamide), poly(hexamethylene isophthalamide), poly(hexamethylene isophthalamide-co-terephthalamide), poly(hexamethylene adipamide-co-isophthalamide), poly(hexamethylene adipamide-co-terephthalamide), poly(hexamethylene isophthalamide-co-terephthalamide) and the like or mixtures thereof. More preferred partially aromatic polyamides include poly(m-xylylene adipamide), poly(hexamethylene isophthalamide-co-terephthalamide), poly(m-xylylene adipamide-co-isophthalamide), and/or mixtures thereof. The most preferred partially aromatic polyamide is poly(m-xylylene adipamide).

Preferred aliphatic polyamides include, but are not limited to poly(hexamethylene adipamide) and poly(caprolactam). The most preferred aliphatic polyamide is poly(hexamethylene adipamide). Partially aromatic polyamides are preferred over the aliphatic polyamides where good thermal properties are crucial.

Preferred aliphatic polyamides include, but are not limited to polycapramide (nylon 6), poly-aminoheptanoic acid (nylon 7), poly-aminonoanoic acid (nylon 9), polyundecane-amide (nylon 11), polyaurylactam (nylon 12), poly(ethylene-adipamide) (nylon 2,6), poly(tetramethylene-adipamide) (nylon 4,6), poly(hexamethylene-adipamide) (nylon 6,6), poly(hexamethylene-sebacamide) (nylon 6,10), poly(hexamethylene-dodecamide) (nylon 6,12), poly(octamethylene-adipamide) (nylon 8,6), poly(decamethylene-adipamide) (nylon 10,6), poly(dodecamethylene-adipamide) (nylon 12,6) and poly(dodecamethylene-sebacamide) (nylon 12,8).

The most preferred polyamides include poly(m-xylylene adipamide), polycapramide (nylon 6) and polyhexamethylene-adipamide (nylon 6,6). Poly(m-xylylene adipamide) is a preferred polyamide due to its availability, high barrier, and processability.

The polyamides are generally prepared by processes that are well known in the art.

The polymers of the present invention may also include additives normally used in polymers. Illustrative of such additives known in the art are colorants, pigments, carbon black, glass fibers, fillers, impact modifiers, antioxidants, stabilizers, flame retardants, reheat aids, crystallization aids, acetaldehyde reducing compounds, recycling release aids, oxygen scavengers, plasticizers, nucleators, mold release agents, compatibilizers, and the like, or their combinations.

The amount of particles incorporated into the polymer depends upon the particular polymer and colorant used. For example, the particles may be incorporated into a polymer in an amount up to about 80% by weight, such as about 50% by weight, especially when forming polymeric films from dissolved polymers. In other embodiments, the particles may be incorporated into the polymeric material in an amount up to about 20% by weight, such as in an amount up to about 10% by weight. When present in the polymer in order to improve the gas barrier properties of the polymer, typically it is desirable to add as little of the particles as possible while maximizing the light fastness of the colorant. In general, the greater the amount of exfoliation of the particles in the polymer the less particles are needed in order to increase the light fastness of the colorant. Of particular advantage, since natural nanoparticles may be easily exfoliated in liquids, relatively low loading of the particles may significantly improve the gas barrier properties of the material in some applications. In these applications, for instance, the particles may be present in the polymer matrix in an amount less than about 5% by weight, such as in an amount from about 0.5% to about 3% by weight.

In one particular embodiment of the present invention, the particles may be incorporated into a polymeric material at relatively high loading. Once dispersed in the polymeric material, the polymeric material and particles mixture may be combined with greater amounts of the polymeric material or with a second polymeric material (e.g., a colored polymeric material) until a desired loading of the particles is achieved.

For example, in one embodiment, the particles may be incorporated into a polymeric material in an amount greater than about 5% by weight, such as in an amount from about 10% to about 20% by weight. Once the particles are dispersed within the polymeric matrix, for instance, the polymer may be pelletized. The pellets containing the particles may then be combined with polymer pellets not containing the particles. Both pellets may then be melt processed together at a selected ratio in order to arrive at an overall particle loading, such as less than about 5%. It is believed that once the particles are exfoliated and dispersed within a polymer, greater amounts of the same polymer or a different polymer may be added later during a melt processing operation and the particles will remain uniformly dispersed through the resulting material. This embodiment of the present invention may provide various processing advantages. For example, when forming polyester articles, such as polyester containers, only a portion of the polyester monomer may need to be polymerized with the particles. The remaining polyester needed to reach the desired loading level may then be added later during formation of the article being produced.

In one particular application, for instance, the particles may be incorporated into a lower molecular weight PET at a relatively high weight loading, such as from about 20% to about 30% by weight. The nanocomposite material may then be diluted using high molecular weight PET via extrusion such that the resulting material has a particle loading of from about 1% to about 5% by weight. The low molecular weight PET and the high molecular weight PET are physically mixed and then extruded to form a PET nanocomposite having the particles dispersed therein.

In another particular embodiment, the polymeric material can include a hydrogel polymer. Generally, a hydrogel is a network of hydrophilic polymers. For instance, hydrogels are insoluble, hydrophilic water-containing gels, which are made from water-soluble polymers. The hydrogel polymers are typically cross-linked, such as chemically cross-linked or physically cross-linked. Physical gels are generally “weaker” than chemical gels. For example, the physical cross-linking of a gel can be destroyed by adding large amounts of solvent. Physically cross-linked hydrogels form polymeric networks with non-covalent interactions, such as ionic bonds, hydrogen bonds, hydrophobic associations, dipole-dipole interactions, and van der Waals forces. For example, poly(vinyl alcohol) (PVA) can be a physically cross-linked hydrogel (though chemically cross-linked PVA networks also exist). Another example of a physically cross-linked hydrogel is agarose. Agarose is a natural linear polysaccharide and forms thermally reversible gels.

According to this embodiment, the nanoparticles are selected to be compatible with the hydrogel polymers. For example, montmorillonite and hectorite are compatible with hydrogel polymers due to their hydrophilic character. Also, chemically cross-linked hydrogels can cross-link with some natural clays, such as montmorillonite. For example, chemically cross-linked hydrogels, such as poly(N-isopropylacrylamide) and poly(N,N-dimethyl acrylamide), can cross-link with montmorillonite rather than conventional organic cross-linkers. The resulting gels have exhibited high deswelling rates and high structural homogeneities.

Once the particles are incorporated into a polymer matrix, the polymeric composite material may be used in various applications. The polymeric composite material may be formed, for instance, into films, fibers, filaments, and into various molded or extruded articles. In one particular application, for instance, the particles may be incorporated into a polyester for forming beverage containers. In another embodiment, the particles may be incorporated into a polymer for forming medical devices, such as devices that are intended to hold or carry blood.

### Colorants

Colorants useful according to the present invention can be any number of compatible colorants, including dyes and pigments. Colorants can be described by their Color Index name, which is an internationally recognized reference to a particular colorant. In one particular embodiment, the colorant is a dye, such as a dye compatible with the particular polymer matrix with which it is associated. Dyes can be classified into many different groups, such as ionic dyes, disperse dyes, vat dyes, and the like. Ionic dyes are typically ionic compounds used in aqueous solution, although some dyes (e.g., disperse dyes) are generally not water soluble.

Ionic dyes can be generally classified by the location of the actual coloring component on one or more of the ions. For example, acid dyes have the coloring component in the anion of the dye, while basic dyes have the coloring component in the cation. Neutral dyes have coloring components in both the anion and cation of the dye. Note that the terms “acid dye,” “basic dye,” and “neutral dye” do not describe the pH of a solution of the particular dye, but rather the location of the coloring component of the dye.

Acid dyes are well known as useful for dying fibers, such as silk, wool, nylon, and modified acrylic fibers. However, their use with polyesters has been somewhat limited due to poor light fastness properties. According to the present invention, however, the light fastness of acid dyes can be improved, even when used with polyesters, by the inclusion of natural nanoparticles. Acid dyes are thought to fix to fibers by hydrogen bonding and are normally sold as a sodium salt (thus, anionic in solution). It is believed that since natural fibers and synthetic nylon fibers contain many cationic sites, there is an attraction of the anionic dye to those cationic sites on the polymer.

Acid dyes encompass a wide variety of chemical compounds and classes. Usually, acid dyes have a sulphonyl or amino group on the molecule making them soluble in water. Acid dyes can include, but are not limited to, anthraquinone-based dyes, azo dyes, and triphenylmethane-based dyes.

Anthraquinone-based dyes, which include, but are not limited to many blue dyes, generally have a structure derived from the following base structure:

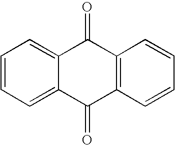

Azo dyes, which include, but are not limited to many red dyes, generally refer to dyes that have at least one azo group in the molecular structure. Azo dyes can be further sub-classified into monoazo, diazo, triazo dyes, and so forth, according to the number of azo groups in the molecule. For example, the first three classifications of azo dyes can be generalized according to the following formulas:

R—N═N—R′ monoazo

R—N═N—R′—N═N—R″ diazo

R—N═N—R′—N═N—R″—N═N—R′″ triazo

wherein R is a cation, H, or an organic group (including both aromatic and aliphatic groups). In many applications, the R groups are aromatic, such as phenyl or phenyl-based groups. It is commonly believed in the art that the delocalization of the electrons in aromatic groups and the azo groups allows the conjugated molecule to absorb visible frequencies of light.

An exemplary diazo acid dye is Acid Red #111 (2,7-naphthalenedisulfonic acid, 3-[[2,2′-dimethyl-4′-[[4-[[(4-methylphenyl)sulfonyl]oxy]phenyl]azo][1,1′-biphenyl]-4-yl]azo]-4-hydroxy-, disodium salt), which is represented by the structure below:

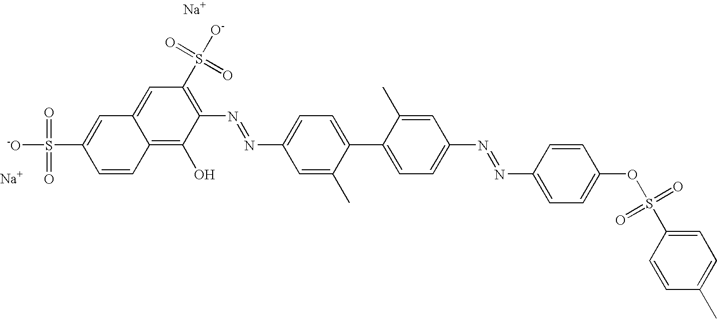

Triphenylmethane-based dyes, which include, but are not limited to many yellow and green dyes, are based on the molecule generally represented below:

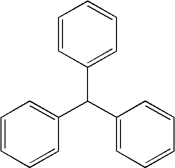

For example, a triphenylmethane-based dye can be Acid Violet #17, a standard dye used for testing light fastness, which is represented by the following structure:

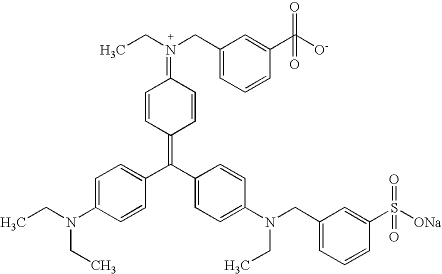

Other types of dyes can be used according to the present invention. For example, water-insoluble disperse dyes can be used in accordance with the present invention.

The dye or other colorant can be added to the polymeric material at any time during its processing. For example, the colorant can be added either before or after the nanoparticles have been added to the polymeric material. In most embodiments, the dye or other colorant will be incorporated into the polymeric matrix, along with the natural nanoparticles. The dye or colorant can be added to the polymeric material according to any process.

The amount of dye or colorant present within the polymeric material can be any amount sufficient to add the desired color to the polymeric material. In fact, the amount of dye or other colorant may be dependent on the particular type of colorant and/or the particular polymeric material used. In most embodiments, the amount of colorant added to the polymeric material is relatively low, such as less than about 5 weight %, such as less than about 3 weight %. For example, in some particular embodiments, the dye can be added to the polymeric material in an amount of from about 0.01 weight % to about 2 weight %, such as from about 0.1 weight % to about 1 weight %.

Polymer Nanocomposite Films with Improved Light Fastness

The present inventors have discovered that through careful selection of natural nanoparticles, the colored nanocomposite materials described herein can have improved light fastness over films comprising the colored polymer with no additional additives. Also, the light fastness of the colored composite polymeric material can be maximized by determining the appropriate amount of nanoparticles to incorporate into the colored polymeric material.

In general, light fastness refers to the degree to which a dye (or other colorant) resists fading due to exposure to light. Commonly, light fastness is judged on a scale of 1 to 8, where 8 is most fade-resistant, although other scales are used. Different colorants have different degrees of resistance to fading by light. For example, all dyes have some susceptibility to light damage, simply because they absorb the wavelengths that they don't reflect back. This absorption of light, which is a form of energy, can serve to degrade the dye molecule.

However, other mechanisms can also contribute to the degradation of the dye molecule. For instance, in some cases, oxygen is required for the damaging reactions of dye chemicals that are caused by light. This is commonly referred to in the art as the photodynamic effect. Without wishing to be bound by theory, it is believed that the photodynamic effect can particularly contribute to the degradation of azo dyes by oxidizing the azo bonds in the dye molecule. For instance, azo dyes may undergo azo-hydrazone tautomerism in the presence of oxygen, which contributes to the fading of the dye.

Thus, due to the improved gas barrier properties of the polymer films having the natural nanoparticles described above, the dyed composite polymer materials of the present invention can be particularly useful to provide improved light fastness to dyes susceptible to photodynamic effects in the presence of oxygen.

Alternatively, another theory suggests that the presence of UV, or other light wavelengths, absorbers in the polymer matrix can increase the light fastness of the dye. For example, the natural nanoparticle may act as a UV stabilizer, and thus contribute to the light fastness of the dyed polymer matrix. In another theory, the dyes may be intercalated into the nanoparticle structure, which may further stabilize the dye.

According to the present invention, the amount of nanoparticles and colorant present in the polymeric material can be adjusted in order to maximize the light fastness of the colored polymeric composite material formed therefrom. For example, depending upon the characteristics of the particular dye used in the polymeric material, a certain nanoparticle can be added in a certain amount in order to maximize its light fastness. For instance, acid dyes, and particularly azo dyes, which are susceptible to degradation when exposed to light in the presence of oxygen can be included into a polymeric material that comprises hectorite in order to maximize the light fastness of the formed colored polymeric material.

The light fastness of the colored polymeric composite material including the natural nanoparticles can be greater than the light fastness of an identical colored polymeric material without the natural nanoparticles present. For example, the presence of the natural nanoparticles can increase the light fastness of the colored polymeric material by at least 5%, such as at least 10% when exposed to light for at least 72 hours.

The present invention may be better understood with respect to the following examples:

### EXAMPLES

To prepare nanocomposite films, dry agarose was suspended in the pre-exfoliated clay suspension and boiled until a clear solution forms. The resulting solution was then poured into petri dishes. Rigid gels were formed upon cooling to room temperature and then allowed to dry and collapse in the air at room temperature. During this gelation process, the clay particles were kept exfoliated and embedded in the agarose network.

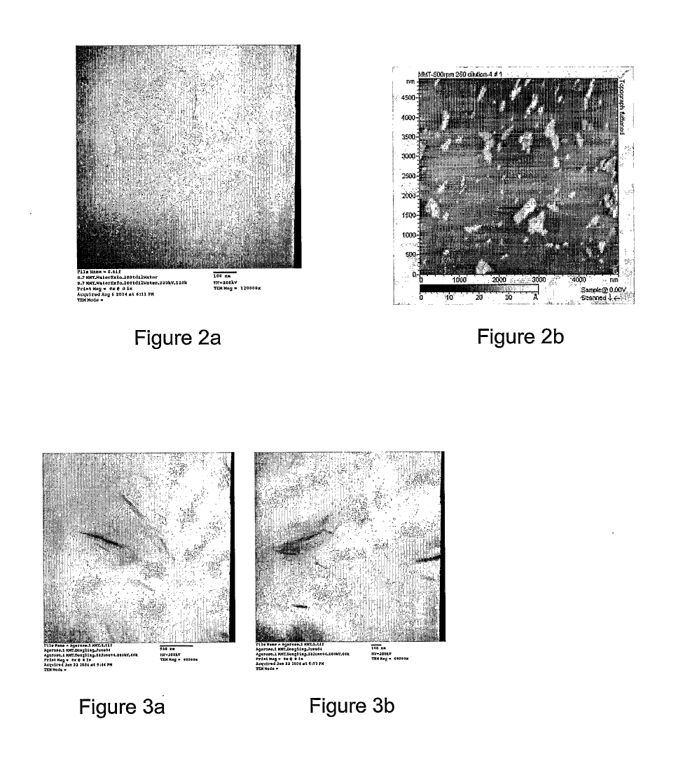

The strategy of the present invention was to exfoliate clay into water first, and then agarose was used to embody the clay in order to prepare nanocomposite film without disturbing the exfoliation. The exfoliation of the montmorillonite in water suspension can be explored using TEM, AFM and DLS to determine particle size and shape. FIG. 2a shows a typical TEM image of montmorillonite in 0.7 wt % montmorillonite water suspension. The AFM image shown in FIG. 2b indicates the montmorillonite platelets are evenly dispersed on mica, and the thickness of platelet is 1.36 nm. The exfoliation of the montmorillonite platelets in composite films can be explored with TEM and XRD as shown in FIG. 3.

The following experiment is provided to further illustrate the production of the polymer/clay nanocomposite films:

### Exfoliation of Montmorillonite:

1% solution of sodium montmorillonite (Cloisite NA+, Southern Clay Products, INC) was dispersed in distilled water. The dispersion was sonicated (Branson 5510) for an hour and then centrifuged (Sorvall Legand T) at 3500 rpm for 75 mins. The upper clear solution was decanted into a silated container. The weight concentration of this exfoliated montmorillonite suspension was 0.7%.

### Preparation of Nanocomposites:

Nanocomposites were prepared by gelation method: agarose (Certified™ PCR) was added to the montmorillonite suspension at a concentration of ≦1 wt %. The mixtures were first heated to 100° C. to dissolve the agarose and then poured into petri dishes. Agarose gels were formed when the mixtures were cooled to room temperature. These gels were dried at room temperature in the air and the nanocomposite films were obtained after the gels collapsed and dried. Different loadings of montmorillonite/agarose films were prepared by varying the ratio of montmorillonite to the amount of agarose added.

### Characterization of the Films:

Transmission electron microscopy (TEM) images were obtained by Hitachi H-8000 at 200 kV. Atomic force microscopy (AFM) images were measured by using a PicoSPM AFM (Molecular Imaging, Phoenix, Ariz.), which was operated in the acoustically driven, intermittent contact (“tapping”) mode. We used standard silicon AFM probes (Mikromasch Ultrasharp NSC12/3), which have cantilever spring constants of 2.5 to 8.5 N/m and resonance frequencies from 120 to 190 kHz. Dynamic light scattering data was collected with a BI-9000AT correlator and LEXEL 95 Ion Laser apparatus (Brookhaven Instrument Corporation) operating at wavelength λ=514.5 nm, which was produced by an Argon laser. Both wide angle and small angle X-ray diffraction data were collected at Brookhaven national lab using Beamline XA32. Thermo gravimetric analysis (TGA) was performed with a TA instruments SDT-29260DTA-TGA apparatus in a flowing He atmosphere using a heating rate of 10° C./min. UV-vis data were collected with Agilent 8453 UV-vis spectrophotometer. Refractive index data were collected with WVASE32 Spectroscopic Elliosometer (J.A. Woollan Co., Inc). Mechanical properties were investigated.

The present invention shows that high weight loading clay nanocomposite films can be achieved without hurting the optical clarity of the polymer in visible range, and that most UV light can be effectively blocked simultaneously. The optical transmittance spectra of nanocomposite films with different weight percentage loading of montmorillonite can be plotted. Nanocomposite film with more than 5 wt % of montmorillonite is able to block the UV light effectively. However, visible light can go through nanocomposites at the same time until the weight percentage of montmorillonite is above about 70%. These results indirectly indicate that montmorillonite is exfoliated in the films and the films have a good optical homogeneity. This attractive observation may find potential application in cosmetics, food packaging, and glass industry.

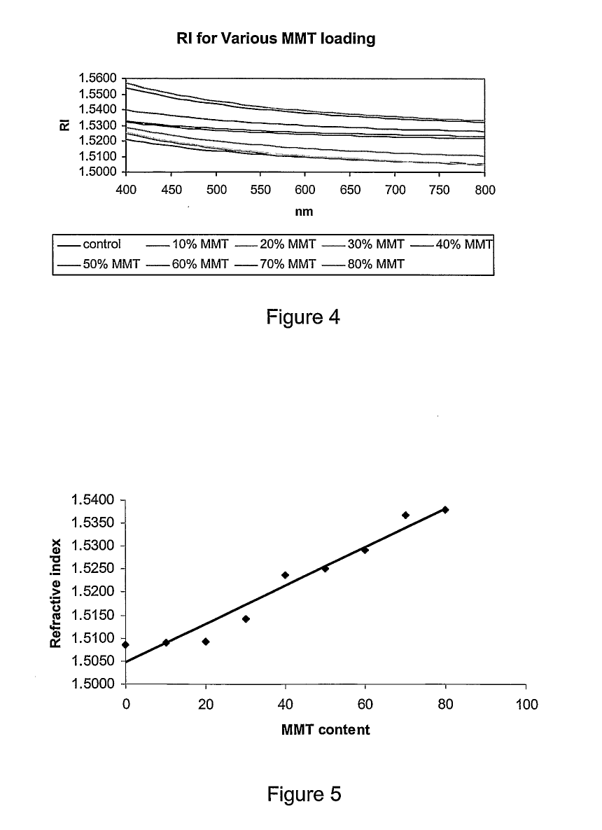

The present invention also shows that high weight loading clay nanocomposite films exhibit high refractive indices. To examine this characteristic, the refractive index (RI) data from polymer nanocomposite films created by the methods described herein were gathered from 400 nm to 800 nm. In this range, the RI of composite films increased as improving the montmorillonite loading as shown in FIG. 4. In order to clearly analyze the effect of montmorillonite on the RI of films, the RI at 630 verses the weight content of montmorillonite are plotted in FIG. 5. The nanocomposite films have refractive indices that increase linearly from 1.509 to 1.538. The refractive index of pure montmorillonite clay is 1.504-1.550. The nanocomposite films exhibiting high refractive indices show interesting potential applications in optical lenses and optical coatings.

Further studies of the high weight loading clay nanocomposite films created using the methods set forth herein have shown that polymer nanocomposite films containing exfoliated montmorillonite clay exhibit improved light fastness over films comprising the polymer with no additional additives. To demonstrate the enhanced light fastness (i.e. resistance to fading), montmorillonite clay is cleaned and dispersed in water. Nanocomposite films are then prepared using the gelation method described above. Dye is added to the mixture before it is allowed to dry. The films are obtained after the gels have collapsed and dried. The films are exposed to light and compared to control films that do not contain the exfoliated clay. Films containing the exfoliated clay consistently show improved light fastness over the control films.

The following experiment is provided to further illustrate the improved light fastness of the polymer/clay nanocomposite films:

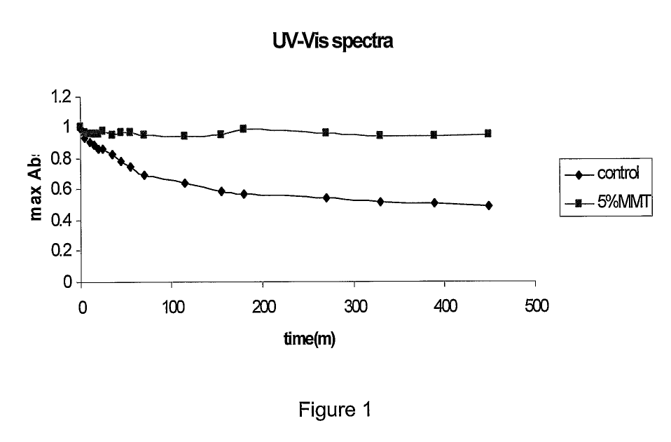

Montmorillonite clay was cleaned and dispersed in water as 1 weight %. Nanocomposite films were prepared by gelation method: agarose (Certified™ PCR) was added to the montmorillonite suspension at a concentration of ≦1 wt %. A yellow dye with poor light fastness was added to the mixture at a 0.23 wt %. The mixtures were first heated to 100° C. to dissolve the agarose and then poured into petri dishes. Agarose gels were formed when the mixtures were cooled to room temperature. These gels were dried at room temperature in the dark, the nanocomposite films were obtained after the gels collapsed and dried. Different loadings of montmorillonite/agarose films were prepared by varying the ratio of montmorillonite to the amount of agarose added. Preliminary tests were carried out with a yellow dye that has poor light fastness. 5 wt % montmorillonite/agarose and control agarose films with the 0.2 wt % dye were prepared with gelation method as described above. The films were exposed to sunlight for a week. The 5 wt % montmorillonite/agarose film did not fade at all, on the other hand the agarose film faded badly. Overhead projectors with halogen lamps were used to accelerate the fastness. The changes of maximum absorption over time were monitored by UV-Vis as shown in FIG. 1. Obviously, the control film faded much quicker than the 5% montmorillonite/agarose film. More accurate tests were investigated under Xenon lamp and the results also indicated that Montmorillonite clay can improve the dye light fastness.

The invention described herein and other modifications and variations to the present invention may be practiced by those of ordinary skill in the art, without departing from the spirit and scope of the present invention. In addition, it should be understood that aspects of the various embodiments may be interchanged, both in whole, or in part. Furthermore, those of ordinary skill in the art will appreciate that the foregoing description is by way of example only, and is not intended to limit the invention so further described in such appended claims.

What is claimed is:

1. A colored polymeric material comprising
a polymer;
a natural nanoparticle, wherein said natural nanoparticle has a greatest dimension of less than about 5,000 nanoparticles; and
a colorant, wherein the colored polymeric material has increased light fastness when compared to an otherwise identical colored control polymeric material without said natural nanoparticles.

2. A colored polymeric material as in claim 1, wherein said colorant comprises a dye.

3. A colored polymeric material as in claim 2, wherein said dye comprises an acid dye.

4. A colored polymeric material as in claim 2, wherein said dye comprises an azo dye.

5. A colored polymeric material as in claim 1, wherein said dye is susceptible to degradation when exposed to light in the presence of oxygen.

6. A colored polymeric material as in claim 1, wherein said natural nanoparticles comprise natural clays.

7. A colored polymeric material as in claim 6, wherein said natural clays are layered in an agglomeration of individual platelet particles that have a thickness of less than about 20 nm and a diameter of about 10 nm to about 5.000 nm.

8. A colored polymeric material as in claim 1, wherein said natural nanoparticles comprise montmorillonite clays.

9. A colored polymeric material as in claim 1, wherein said dye comprises from about 0.01 weight % to about 5 weight % of the polymeric material.

10. A colored polymeric material as in claim 1, wherein said natural nanoparticles comprise from about 0.1 weight % to about 10 weight % of the polymeric material.

11. A colored polymeric material as in claim 1 wherein the polymeric material defines a film.

12. A colored polymeric material as in claim 1, wherein said polymer is selected from the group consisting of polyesters, polyetheresters, polyamides, polyesteramides, polyurethanes, polyimides, polyetherimides, polyureas, polyamideimides, polyphenyleneoxides, phenoxy resins, epoxy resins, polyolefins, polyacrylates, polystyrenes, polyethylene-co-vinyl alcohols, polyvinyl chlorides, polyvinyl alcohols, cellulose acetates, agarose, and copolymers and combinations thereof.

13. A colored polymeric material as in claim 1, wherein said polymer comprises a hydrogel polymer.

14. A dyed polymeric material comprising
a hydrogel polymer that forms a cross-linked matrix, wherein said cross-linked matrix is chemically cross-linked or physically cross-linked;
natural clay nanoparticles, layered in an agglomeration of platelet particles, having a greatest dimension of less than about 5,000 nm; and
a dye, wherein the dyed polymeric material has increased light fastness when compared to an otherwise identical dyed control polymeric material without said natural nanoparticles.

15. A dyed polymeric material as in claim 14, wherein said platelet particles have a thickness of less than about 20 nanometers.

16. A dyed polymeric material as in claim 14, wherein said natural clay nanoparticles comprise montmorillonite clays.

17. A dyed polymeric material as in claim 14, wherein said dye comprises from about 0.01 weight % to about 5 weight % of the polymeric material.

18. A dyed polymeric material as in claim 14, wherein said natural clay nanoparticles comprise from about 0.1 weight % to about 10 weight % of the polymeric material.

19. A dyed polymeric material as in claim 14, wherein said dye comprises an acid dye that is susceptible to degradation when exposed to light in the presence of oxygen.

20. A method of making a colored polymeric material having increased light fastness, the method comprising:
exfoliating natural clay nanoparticles into a polymeric material, wherein said natural clay nanoparticles have a greatest dimension of less than about 5,000 nm, a thickness of less than about 20 nm, and are selected from the group consisting of smectite clays and modified clays; and
dying the polymeric material with a dye that is susceptible to degradation when exposed to light in the presence of oxygen.
